(19) United States
(12) Patent Application Publication
(10) Pub. No.: US 2008/0270169 A1
(43) Pub. Date: Oct. 30, 2008

(54) Peer ranking

(75) Inventors: Osman Kibar, San Diego, CA (US); Eugene M. Izhikevich, San Diego, CA (US)

Correspondence Address: FISH & RICHARDSON PC, P.O. BOX 1022, MINNEAPOLIS, MN, 55440-1022, US

(73) Assignee: Dynamic Connections, LLC, San Diego, CA (US)

(21) Appl. No.: 12/108,865

(22) Filed: Apr. 24, 2008

Related U.S. Application Data
(60) Provisional application No. 60/913,699, filed on Apr. 24, 2007.

(51) Int. Cl. G06Q 10/00

(52) U.S. Cl. 705/1

(57) ABSTRACT

Among other things, with respect to entities each of which has attributes from which a value of the entity to an aspect of one or more fields of human activity can be evaluated subjectively, accumulating subjective information interactively and electronically from people who are experts or peers in one or more of the fields of human activity concerning the value of the entities to the aspect of one or more of the fields, and automatically generating data about relative values of at least some of the entities to the aspect of at least one of the fields based on at least some of the accumulated subjective information.

### CROSS REFERENCE TO RELATED APPLICATIONS

This application claims priority from U.S. provisional application 60/913,699, filed on Apr. 24, 2007, which is incorporated by reference.

### TECHNICAL FIELD

This invention relates to determining ranks and relevance based on subjective opinions.

### BACKGROUND

This description relates to determining ranks and relevance based on subjective opinions.

A lot of things, including people, companies, and events, are ranked based on their attributes. For example, companies are ranked by their size, revenue, or market cap; websites are ranked by their Google PageRank or web traffic; and people are ranked by their IQ, education, or work experience. Most of the attributes that underlie the rankings are quantifiable, objective criteria that do not represent more subjective features such as quality or usefulness or other, which are critical indicators of future performance.

Online resume depositories, such as CareerBuilder.com, Monster.com, and Dice.com, process and objectively rank applicants' resumes before showing them to recruiters or employers. There are two ways typically used to collect information for objective ranking of a job applicant's professional qualities.

In one method, an applicant creates his own objective profile, e.g., by filling out a questionnaire to indicate his education, experience, field of expertise, location, expected salary range, and other professional attributes.

In the second way, relevant keywords are extracted from the applicant's resume, e.g., names of companies the applicant previously worked for and names of software packages and operating systems within the applicant's expertise. Then, heuristic algorithms sift through a set of resumes and select those that provide a best fit for a particular job description. Such algorithms are developed by the electronic resume depositories using pattern recognition and artificial intelligence techniques.

The algorithms reduce the number of resumes that are considered relevant to a particular job description, from thousands or more to tens of resumes or fewer. Then the recruiters or other people apply their own subjective criteria to further screen the remaining tens of resumes to derive a short list of only a few candidates. The screeners can pay attention to subjective features such as the title or the position of an applicant in previous jobs, the length of his period of unemployment, or his experience with certain products. Thus, recruiters try to understand the significance of resumes at a level that is difficult to automate using a computer heuristic algorithm, for example, whether attributes of the applicant are predictors of an employee's future performance at a particular job or company.

### SUMMARY

In general, in an aspect, with respect to entities each of which has attributes from which a value of the entity with respect to an aspect of one or more fields of human activity can be evaluated subjectively, accumulating subjective information interactively and electronically from people who are experts or peers in one or more of the fields of human activity concerning the value of the entities with respect to the aspect of one or more of the fields, and automatically generating data about relative values of at least some of the entities with respect to the aspect of at least one of the fields based on at least some of the accumulated subjective information.

Implementations may include one or more of the following features. The entities include job applicants. The entities include job descriptions. The entities include resumes. The entities include professional qualities of people.

The aspect includes a job. The job is for full-time employment. The job is for part-time employment. The job is for consulting. The job is for contracting. The aspect includes a skillset. The aspect includes expertise. The aspect includes experience.

The fields of human activities include fields of work. The fields of work include management. The fields of work include technical work. The fields of work include artistic work.

The value includes a relevance of an entity to an aspect of a field of human activity. The value includes a level of quality of an entity with respect to its participation in an aspect of a field of human activity. The value includes a level of interest of an entity with respect to its participation in an aspect of a field of human activity.

The attributes include characteristics that subjectively reflect the capability of a human being. The attributes include characteristics that span more than one field of human activity. The attribute includes creativity. The attribute includes technical skills. The attribute includes artistic skills. The attribute includes management skills. The attribute includes ability to work in a team. The attribute includes interpersonal skills. The attribute includes expertise. The attribute includes ability to work long hours. The attribute includes ability to meet deadlines. The attribute includes ability to work under pressure.

The information is accumulated through web browsers. The information is accumulated through mobile devices.

The automatically generated data includes a matrix of the relevance of one of the entities to the aspect of a field of human activity. The automatically generated data includes a matrix of comparisons of different ones of the entities in terms of their relative values. The automatically generated data includes a matrix of interests of different ones of the entities in the aspects of the field of human activity.

The subjective information with respect to an entity is accumulated from the entity itself. The subjective information with respect to an entity is accumulated from other entities.

The generated data available is made available to users. The generated data is made available online to users. The users include the entities. The users include representatives of the aspect of the fields of human activity. The representatives include employers. The users include intermediaries between the entities and the aspect of the one or more fields of human activity. The intermediaries include job recruiters. The generated data is used to match the entities with the aspects of the fields of human activity. The data is automatically generated by quantitative analysis of the accumulated subjective information. The data is automatically generated by statistical analysis of the accumulated subjective information. Summaries of the entities are accumulated. The summaries include resumes. Summaries of the aspects of the fields of human activities are accumulated. The summaries include job descriptions.

In general, in an aspect, information about entities is made available to users, the information including attributes from which a value of the entity with respect to an aspect of one or more fields of human activity can be evaluated, enabling users to interactively evaluate the entities with respect to one or more of the attributes or of the aspects, and automatically generating data about the evaluated entities.

In general, in an aspect, with respect to job applicants who have attributes, from which a value of each applicant with respect to one or more skill sets can be evaluated subjectively, accumulating subjective information interactively and electronically from people who are experts or peers in the one or more skill sets concerning the value of the entities with respect to the one or more skill sets, and automatically generating data about relative values of at least some of the applicants with respect to at least one of the skill sets based on at least some of the accumulated subjective information.

These and other features and aspects, and combinations of them, can be expressed as methods systems, apparatus, program products, means and steps for performing a function and in other ways.

Other features and aspects will be apparent from the following description and claims.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1 and 2 are block diagrams.

### DETAILED DESCRIPTION

We describe an automated system that, in some implementations, ranks the professional qualities of people and their relevance for particular jobs in particular fields, quantitatively and statistically, based on the subjective opinions of other professionals in the same or similar fields (who may be considered experts in the relevant fields, especially compared to job recruiters). The system that we describe need not rely on algorithms that are based only on applicant-provided data or keyword-oriented processing.

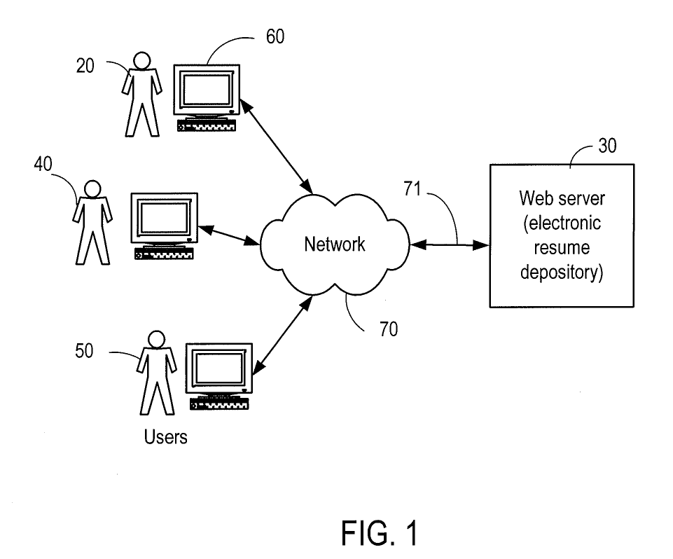

As shown in FIG. 1, in some implementations, users (e.g., an applicant 20, a recruiter 40, an employer 50) use a network 70 to access 71 a web server 30 that provides a user interface, for example, through a web browser implemented on a computer 60.

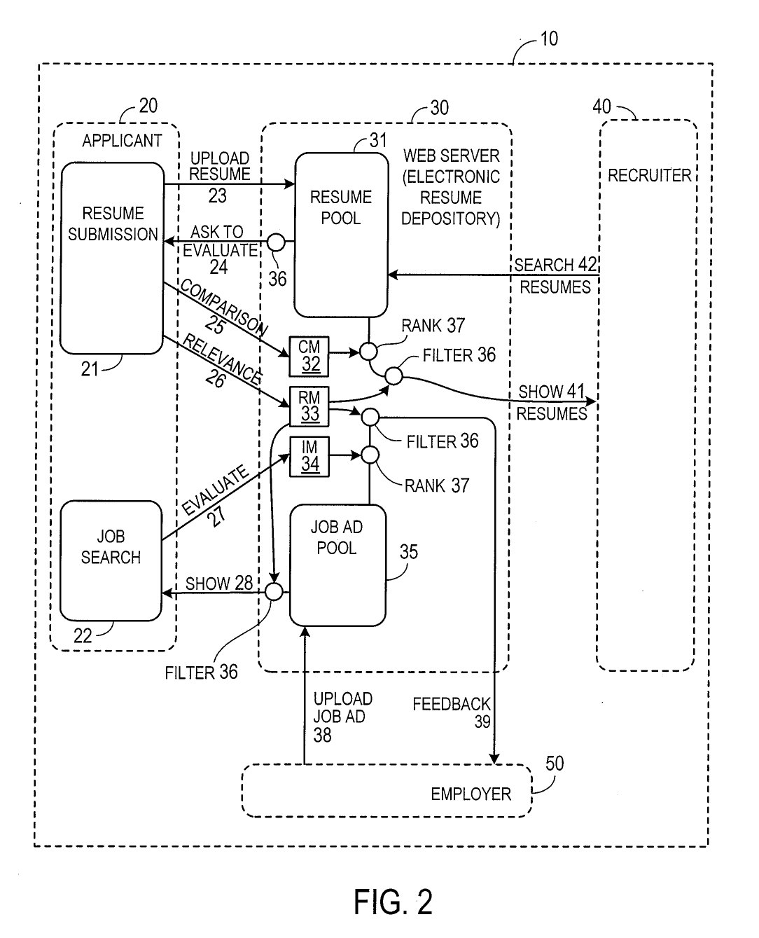

Referring to FIG. 2, the server 30 stores a resume database 31 (called a “resume pool” in the figure) and a job database 35 (called a “job ad pool” in the figure) that are available to clients (e.g., an applicant 20, a recruiter 40, an employer 50). The clients include applicants (e.g., applicant 20) who want to upload 23 their resumes to the server 30 in connection with job searching 22, recruiters (e.g., recruiter 40) who want to search 42 the resume database for applicants to present to employers, and employers (e.g., employer 50) who want to upload 38 job advertisements to attract applicants.

In this example, the server 30 also contains three matrices, relevance matrix (RM) 33, comparison matrix (CM) 32, and interest matrix (IM) 34, described below. These matrices are built according to the responses of applicants posed to them as part of a process of registering to participate and uploading 23 their resumes. The matrices are used to rank 37 resumes and provide structural responses to applicants, recruiters, and employers.

When an applicant uploads 23 his resume, he is asked to evaluate 24 the relevance and the quality of other applicants' resumes. These evaluations are then used both to determine the relevance 26 of each resume, which builds the relevance matrix 33, and to form comparisons 25, which constructs the comparison matrix 32. The relevance matrix 33 is used to filter 36 applicants and to identify clusters of applicants that are in the relevant job domains; whereas the comparison matrix 32 is used to rank 37 resumes within each cluster and present ranking information (e.g., show 41 resumes) to recruiters and employers.

Applicants can also browse through job ads (e.g., ads in the job ad pool 35 can be shown 28 to the applicant 20). Applicants can evaluate 27 the ads, and indicate which ads are interesting to them. Their indications are used to build the interest matrix 34. This matrix is used to rank 37 jobs and then to filter 36 the jobs so that jobs of interest can be identified to applicants within a given cluster.

In addition, the system can provide feedback to employers (e.g., feedback 39), or to applicants or to recruiters. An applicant can see for which jobs he was considered and what his rank was with respect to other applicants for each of the jobs (e.g., whether he made the cut or not, and by how much). Employers can see how many and what kind of applicants expressed interest in their job ads. And a recruiter could see both kinds of information.

We now explain the process in more detail.

### The Upload Process

An applicant (e.g., applicant 20) can upload 23 his resume to the server 30, for example, in any typical text file format. The applicant then interactively fills out a quantitative questionnaire, indicating the domain (we use “domain” and “field” interchangeably) of his experience and expertise (e.g., software engineer, nurse, manager), as well as other attributes. This is similar to a typical first step in any job application process. The upload process can be done online (in various modes, e.g., through a computer 60 using an internet server, through a mobile device) or off-line (e.g., by fax).

In addition, the applicant 20 indicates whether he will allow (consent to) his resume being rated, which involves showing it to other applicants and professionals who are not applicants in his domain(s) and related domain(s). If he agrees, then his resume becomes a part of the resume pool 31 to be rated, and the applicant proceeds to “crowdsourcing” (described below) and agrees to terms of confidentiality for his attributes. For example, the applicant may ask that his name and his current company be withheld in the comparisons.

### Crowdsourcing

Crowdsourcing is a business model in which a company outsources a particular job to a large number of unspecified people, typically without any compensation (see, for example, http://en.wikipedia.org/wiki/Crowdsourcing).

After uploading 23 his resume, the applicant 20 is shown resumes of other applicants and he is asked to evaluate 24 them based on a number of attributes (e.g., experience, professional quality, appearance of resume). Among the rating methods that can be used are two described below.

In one rating method, the applicant 20 is shown pairs of resumes (of others) and he indicates which one of the two resumes of each pair is better. The answer can be binary (e.g., resume A is better than resume B), or it can be graded (e.g. on a scale from −10 to +10, with −10 corresponding to resume A being much better than resume B, and vice versa for +10). The applicant can be asked to grade N such pairs (e.g., N=10). In addition, the applicant indicates whether the two resumes are comparable, i.e., belong to the same domain or not. The answer can be binary (i.e., yes or no) or graded (e.g. from 0 for “definitely no,” to 0.5 for “sort of,” to 1.0 for “exactly the same”). An optimization algorithm can be used to increase or to decrease the number N for each applicant, based on the required number for statistical analysis, particular fields, number of existing applicants, and other factors. N can be fixed or can change over time based on various factors.

In a second method of rating, the applicant 20 is shown only one resume at a time and is asked to rate it relative to his own resume. The rating can be binary (i.e., “I'm better” vs “he's better”) or graded (e.g., from −10 for “I'm so much better” to +10 for “he's so much better”). The rating exercise can be done for N different resumes. As described above, N can be changed by an optimization algorithm. The exact values of the grades are not significant, because the system in this example does not compare his resume with the others, but rather analyzes the relative distribution of numbers for all the other resumes. For example, if resume A was given −3 and resume B was given +5, then resume B is better than resume A by 8 points. As in the first rating method, the applicant is asked to evaluate how comparable the domain involved in each of those resumes is to the domain reflected on his own resume; in other words, how close the other person's field is to his own. The answer could be binary or graded.

Some applicants may find one or the other rating method easier and can be asked which should be used, one or the other or a mix of the two (such as a random mix). The applicants will typically use both objective and subjective criteria in their performing the requested ratings. For example, they may decide that 10 years of experience is worth more than a PhD degree in one line of work, but not so in another.

The crowdsourcing process produces two sets of results: one pertains to the subjective relevance of resumes to various domains (stored in the relevance matrix), and the other to the subjective quality of each resume within its domain(s) (stored in the comparison matrix).

### Matrix Analysis of Rank and Relevance

The system evaluates resumes based, at least in part, on the data contained in the relevance matrix 33 and the comparison matrix 32.

### Relevance Matrix

The relevance matrix 33 is a sparse matrix that assigns to some pairs (A, B) a coefficient, say between 0 and 1, where A and B are resumes of two different applicants.

Because most resumes have never been compared one on one against each other, most entries of this matrix will initially be undetermined. However, the relevance between any two resumes can be found using graph-theoretical approaches. In some implementations, if A is relevant to B with the coefficient pAB=0.8 and B is relevant to C with coefficient pBC=0.9, then A is relevant to C with coefficient pAC=0.8×0.9=0.72.

In general, one can implement a function of two arguments, pAC=f(pAB, pBC), which can comprise a simple product, as above, a minimum-function, or any other function. In some implementations, to determine the relevance of A to C, all resumes are considered as vertices of a graph. All paths from A to C (i.e., A is comparable to B, B to D, D to F, F to G, and finally G to C) and the weights along each such path are determined. Then, the sum (or average, or any other function) of the weights of these paths can be used as an indicator of the relevance of A to C.

Knowing the relevance of a sufficiently large number of pairs of resumes, one can use this matrix to determine the relevance of any two resumes. In addition, one can use standard methods of cluster analysis to determine clusters of resumes that are relevant to each other, but not relevant to resumes in other clusters. These clusters would correspond to separate professional domains, e.g., web designer, software engineer, software architect. Thus clusters are like domains or fields.

### Comparison Matrix

The comparison matrix 32 is also a sparse matrix that assigns to each pair of resumes a number that reflects the relative quality of the two resumes of the pair. Because most resumes have never been compared one on one against each other, most elements of this matrix will initially be undefined. This matrix is used to determine absolute ranks of resumes in general or within a field or domain.

In a simple implementation, each resume is assigned a rank equal to the proportion of instances the resume was ranked higher than other resumes. For example, if a resume was compared against 10 other resumes and it was rated higher 7 times, then its rank can be set at 0.7.

In other implementations, the rank, as determined in the simple way, is increased or decreased depending on the ranks (i.e., the strengths) of other resumes with which this resume was compared. If the other resumes had higher rankings (that is, they won in comparison with many other resumes) and the current resume was rated even higher, then its rank is increased proportionately. If the other resumes have low ranks (that is, they lost to many other resumes) and the current resume was rated lower, its rank is decreased accordingly. Mathematically, this procedure is related to finding the eigenvectors of the comparison matrix. A matrix of ranks can be formed.

If there are multiple features (also called “attributes”) on which resumes are compared, then a relevance matrix 33 and a rank matrix will be created for each feature. For the relevance matrix 33, such features can include a wide variety of attributes including multidisciplinary jobs, level of innovation that is required, number of hours (or exact time of day) the position requires, among others. For the rank matrix, the features can include a wide variety of attributes, including expertise in a particular field, qualifications and experience in that field, and level of creativity that is desired of the applicant, among others.

Each applicant (e.g., applicant 20) can select more than one job domain for his participation in the system, and he can be asked to rate resumes in each category (we sometimes refer to “domains” or “fields” as “categories”). In turn, the applicant's resume will be rated and compared with other resumes in each category, so that it can have separate ranks for each category. For example, the resume of a software engineer who knows statistics can be compared with resumes of other software engineers and with resumes of other statisticians, thereby acquiring two ranks. In this case, recruiters can ask, “Show me resumes with a rank of at least X in software engineering and at least Y in statistics”, or variations of queries that impose restrictions on the rank of resumes in multiple job domains. In general, a rich and deep set of features can be provided for querying the system to find resumes that may be relevant to particular jobs and employers.

### User-Controlled Analysis

The recruiter (e.g., recruiter 40) or the employer (e.g., employer 50) or other parties who are given access can search the resume database 31 and extract useful information in several steps.

For example, recruiters can choose an expertise domain, keywords of interest, or other predetermined criteria, and select all resumes from the resume database 31 that satisfy one or more of these criteria. This would be a standard step for searches in the electronic resume depositories on the server 30. The resulting selection could comprise thousands of seemingly relevant resumes.

Using the relevance matrix 33, the server 30 could help the recruiter or other searcher to identify clusters of resumes that fit the search criteria. Recruiters can select one or more clusters, thereby narrowing further their search, based on the evaluations of resumes by applicants.

The server 30 can sort the resulting resumes within each cluster according to the resume rank and present to the recruiters “the best M resumes” (M is determined by the user) or the resumes ranked within a range (again, this range is determined by the user).

Recruiters or employers and other searchers can repeat the steps to narrow the search results until they arrive at a small number of highly relevant and highly ranked resumes pertinent to the job. For example, they can find one or a few resumes that fit the job description precisely and then ask the server to show all resumes that are most relevant to these resumes. Alternatively, they may ask to see only the best resumes and relax the applicant's relevance to the job description, thereby seeing only the highest quality applicants that are close to, but not necessarily exactly matching, the job description. Or they may choose a combination of the two inquiries, where they can select a range for both rank and relevance, e.g., “show me most relevant resumes with sufficiently high rank and/or highest ranked resumes with sufficiently high relevance”.

The system 30 can also be used by companies to evaluate and to assess the resumes of their own employees (internally compared against each other or compared against outside applicants), to be used as performance measures towards promotion or towards hiring and firing decisions.

All recruiters' activities and queries will be stored on the server 30 so that this information can be used to provide constructive feedback to applicants. An applicant (e.g., applicant 20) can be allowed to see the list of candidate searches by recruiters (e.g., recruiter 40) for which his resume made the cut, i.e., was shown to the recruiter. He can also see the searches in which his resume did not make the cut; he then can ask to see a sample resume that did make the cut, so that he can better understand the recruiting process, the strong and weak features of his own resume compared to others', and how far off he was from making the cut. In addition, he can make inquiries to the server, such as: “show me all possible job searches where I would be in the top 50 candidates”.

The system 10 can also be useful in the job advertisement markets. Applicants spend a large amount of time searching through job ads (e.g., ads in job ad pool 35) that are posted by employers (e.g., employer 50). Typically, the ads are sorted according to keywords and posting date. An applicant spends a few minutes per job ad to assess whether the job description fits his expertise and interests. Because most of the job ads are irrelevant, the applicant wastes a lot of time sifting through the job posts until he is able to find something that is relevant for himself.

In the system 10 that is described here, an applicant (e.g., applicant 20) can evaluate 27 job ads with respect to how interesting (or relevant) they are to him. This information is used to build the interest matrix (IM) 34. The rating could be binary (e.g., yes=interesting, or no=not interesting) or graded (e.g., from 0=not interesting at all, to 1=exact fit). The information in the interest matrix and in the relevance matrix can be used to identify the jobs that are most interesting to a particular cluster of resumes. This way, an applicant can rank 37 all jobs with respect to how interesting these jobs are to other applicants with relevant resumes. Instead of browsing through all the job ads, other applicants then will be able to identify the most relevant or interesting jobs first and in a much shorter time. This information can also be used by the employer or by the recruiters to identify which clusters or groups of applicants express the most interest in particular job ads and to adjust the job descriptions accordingly.

The described system can also be used for the consultancy market. Quite often, companies have small projects whose completion would require a few weeks to a few months of work for an expert consultant. However, the funding available for the project may prevent the company from employing professional recruiters to find a suitable consultant or from hiring a full-time employee to accomplish the task. Such companies can post their project descriptions to the server 30 and let a consultant evaluate the appeal and compensation for each project. Not only would the companies see which of the applicants express interest in the job, or the clusters of resumes that fit the job description, but also, they can rank each applicant according to his resume rank, and identify potential consultants for their projects. This way, the crowdsourcing would enable the companies with small projects to outsource the evaluation of the most suitable applicants for their projects to the applicants and the experts in that field themselves.

The above-described system 10 can also be used to provide ranking and relevance regarding various attributes of other products, companies, individuals, and systems.

What is claimed is:

1. A method comprising
for entities, each of which has attributes from which a value of the entity with respect to an aspect of one or more fields of human activity can be evaluated subjectively,
accumulating subjective information interactively and electronically from people who are experts or peers in one or more of the fields of human activity concerning the value of the entities with respect to the aspect of one or more of the fields, and
automatically generating data about relative values of at least some of the entities with respect to the aspect of at least one of the fields based on at least some of the accumulated subjective information.

2. The method of claim 1 in which the entities comprise job applicants.

3. The method of claim 1 in which the entities comprise job descriptions.

4. The method of claim 1 in which the entities comprise resumes.

5. The method of claim 1 in which the entities comprise professional qualities of people.

6. The method of claim 1 in which the aspect comprises a job.

7. The method of claim 6 in which the job is for full-time employment.

8. The method of claim 6 in which the job is for part-time employment.

9. The method of claim 6 in which the job is for consulting.

10. The method of claim 6 in which the job is for contracting.

11. The method of claim 1 in which the aspect comprises a skill set.

12. The method of claim 1 in which the aspect comprises expertise.

13. The method of claim 1 in which the aspect comprises experience.

14. The method of claim 1 in which the fields of human activities include fields of work.

15. The method of claim 14 in which the fields of work comprise management.

16. The method of claim 14 in which the fields of work comprise technical work.

17. The method of claim 14 in which the fields of work comprise artistic work.

18. The method of claim 1 in which the value comprises a relevance of an entity to an aspect of a field of human activity.

19. The method of claim 1 in which the value comprises a level of quality of an entity with respect to its participation in an aspect of a field of human activity.

20. The method of claim 1 in which the value comprises a level of interest of an entity with respect to its participation in an aspect of a field of human activity.

21. The method of claim 1 in which the attributes comprise characteristics that subjectively reflect the capability of a human being.

22. The method of claim 1 in which the attributes comprise characteristics that span more than one field of human activity.

23. The method of claim 1 in which the attribute comprises creativity.

24. The method of claim 1 in which the attribute comprises technical skills.

25. The method of claim 1 in which the attribute comprises artistic skills.

26. The method of claim 1 in which the attribute comprises management skills.

27. The method of claim 1 in which the attribute comprises ability to work in a team.

28. The method of claim 1 in which the attribute comprises interpersonal skills.

29. The method of claim 1 in which the attribute comprises expertise.

30. The method of claim 1 in which the attribute comprises ability to work long hours.

31. The method of claim 1 in which the attribute comprises ability to meet deadlines.

32. The method of claim 1 in which the attribute comprises ability to work under pressure.

33. The method of claim 1 in which the information is accumulated through web browsers.

34. The method of claim 1 in which the information is accumulated through mobile devices.

35. The method of claim 1 in which the automatically generated data includes a matrix of the relevance of one of the entities to the aspect of a field of human activity.

36. The method of claim 1 in which the automatically generated data includes a matrix of comparisons of different ones of the entities in terms of their relative values.

37. The method of claim 1 in which the automatically generated data includes a matrix of interests of different ones of the entities in the aspects of the field of human activity.

38. The method of claim 1 in which the subjective information with respect to an entity is accumulated from the entity itself.

39. The method of claim 1 in which the subjective information with respect to an entity is accumulated from other entities.

40. The method of claim 1 also including making the generated data available to users.

41. The method of claim 1 also including making the generated data available online to users.

42. The method of claim 40 in which the users comprise the entities.

43. The method of claim 40 in which the users comprise representatives of the aspect of the fields of human activity.

44. The method of claim 43 in which the representatives comprise employers.

45. The method of claim 40 in which the users comprise intermediaries between the entities and the aspect of the one or more fields of human activity.

46. The method of claim 45 in which the intermediaries comprise job recruiters.

47. The method of claim 1 also including using the generated data to match the entities with the aspects of the fields of human activity.

48. The method of claim 1 in which the data is automatically generated by quantitative analysis of the accumulated subjective information.

49. The method of claim 1 in which the data is automatically generated by statistical analysis of the accumulated subjective information.

50. The method of claim 1 also including accumulating summaries of the entities.

51. The method of claim 50 in which the summaries comprise resumes.

52. The method of claim 1 also including accumulating summaries of the aspects of the fields of human activities.

53. The method of claim 52 in which the summaries comprise job descriptions.

54. A method comprising
making available to users information about entities, the information comprising attributes from which a value of the entity with respect to an aspect of one or more fields of human activity can be evaluated;
enabling users to interactively evaluate the entities with respect to one or more of the attributes or of the aspects; and
automatically generating data about the evaluated entities.

55. A method comprising
for job applicants who have attributes, from which a value of each applicant with respect to one or more skill sets can be evaluated subjectively,
accumulating subjective information interactively and electronically from people who are experts or peers in the one or more skill sets concerning the value of the applicants with respect to the one or more skill sets, and
automatically generating data about relative values of at least some of the applicants with respect to at least one of the skill sets based on at least some of the accumulated subjective information.
